(19) United States
(12) Patent Application Publication
(10) Pub. No.: US 2006/0048118 A1
(43) Pub. Date: Mar. 2, 2006

(54) Method and apparatus for optimizing code with artificial statements

(75) Inventors: Roch Georges Archambault, North York (CA); Peng Zhao, East York (CA)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/930,041

(22) Filed: Aug. 30, 2004

(51) Int. Cl. G06F 9/45

(52) U.S. Cl. 717/151

(57) ABSTRACT

A method, apparatus, and computer instructions for facilitating optimization of code. An artificial statement is placed into the code. The artificial statement encodes information. The code is optimized with a compiler. The compiler performs an action based on the artificial statement in the code.

### BACKGROUND OF THE INVENTION

1. Technical Field

The present invention relates generally to an improved data processing system and in particular to a method and apparatus for processing data. Still more particularly, the present invention relates to a method, apparatus, and computer instructions for optimizing code in a compiler.

2. Description of Related Art

A compiler is a program that executes in a data processing system. A compiler translates a high-level language program into a functionally equivalent low-level language program. The high-level language program also is referred to as the source code or source program. The low-level language program may take the form of machine language instructions. In the process of compiling source code into machine code, the compiler optimizes the source code by generating an explicit intermediate representation of the source code. The compiler performs code optimization on the intermediate representation. In optimizing code, compilers may include features to optimize the performance of the program. Different optimizations may be performed by the compiler. These optimizations include, for example, branch optimization, code motion, common sub expression elimination, constant propagation, dead code elimination, inlining, and instruction scheduling. These optimizations also may involve aggressively copying expressions into loops to create opportunities for loop transformations. One problem with this type of aggressive copying of expressions into loops is that the compiler may not know if a pointer contains a valid address if the expression is moved outside of the loops. Other unsafe operations also may exist. For example, the square root is not safe if the value feeding the square root function is negative. In a similar function, a modular/divide operation might generate a trap or exception when the divisor is zero unless the target platform allows for these types of operations. One solution to this problem of invalid operations with aggressive copying is using a hash table to remember the origination point of each expression being copied. Such a solution is fairly expensive and not easy to maintain with respect to compiler processing.

Therefore, it would be advantageous to have an improved method, apparatus, and computer instructions for compiling instructions.

### SUMMARY OF THE INVENTION

The present invention provides a method, apparatus, and computer instructions for facilitating optimization of code. An artificial statement is placed into the code. The artificial statement encodes information for use by the compiler. The code is optimized with a compiler. The compiler performs an action based on the artificial statement in the code.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a diagram of components used in compiling software in accordance with a preferred embodiment of the present invention;

FIG. 4 is a flowchart of the process for optimizing code using artificial statements in accordance with a preferred embodiment of the present invention;

FIG. 5 is a flowchart of a process for optimizing code using POP statement in accordance with a preferred embodiment of the present invention;

FIG. 6 is a diagram illustrating optimization of code in accordance with a preferred embodiment of the present invention; and

FIG. 7 is a diagram illustrating the use of the POP statement and modifying loop structures in accordance with a preferred embodiment of present invention.

### DETAILED DESCRIPTION OF THE PREFERRED EMBODIMENT

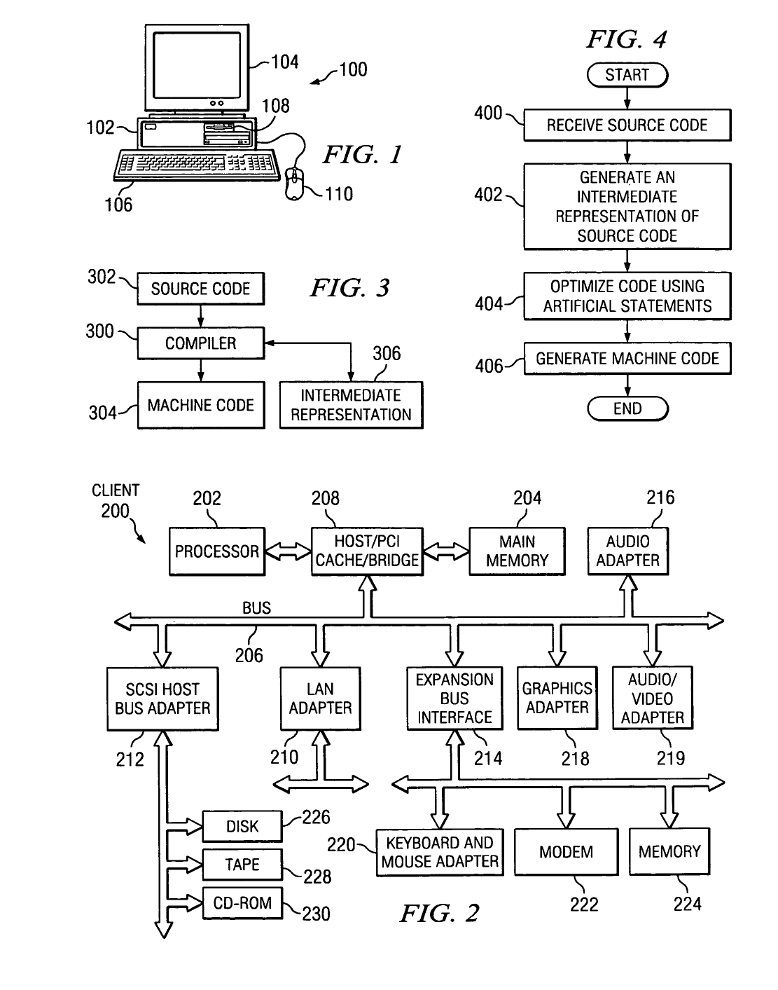

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer™ computer or IntelliStation® computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in connectors. In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

Turning next to FIG. 3, a diagram of components used in compiling software is depicted in accordance with a preferred embodiment of the present invention. Compiler 300 is software that converts a set of high-level language statements into a lower-level representation. In this example, the higher-level statements are present in source code 302. Source code 302 is written in a high-level programming language, such as, for example, C and C++. Source code 302 is converted into machine code 304 by compiler 300.

In the process of generating machine code 304 from source code 302, compiler 300 creates intermediate representation 306 from source code 302. Intermediate representation 306 is code in a form processed by compiler 300 during which optimizations to the software may be made. After the optimizations have occurred, machine code 304 is generated from intermediate representation 306.

The present invention provides an improved method, apparatus, and computer instructions for compiling instructions. The mechanism the present invention creates or uses artificial statements to track references of the origination of references in the code being processed. The mechanism may associate the information needed for properly optimizing the code. In these examples, the artificial statements take the form of POP statements. These POP statements feed into various optimizing transformations as normal statements. With the special property of these POP statements, they can be easily identified.

When the compiler encounters an artificial statement, such as a POP statement, this statement is easily identified based on their artificial and unique nature in these illustrative examples. The POP statement in these examples serves as a marker for the expression being copied that potentially cannot be moved back to the original position. Additionally, the POP statement also works as a directive and does not produce actual machine code in these illustrative examples. With POP statements that are loop oriented, when a loop structure changes, the information also may be propagated by making copies of the POP statement in the original loop structure. For example, if a single loop structure is combated into two loop structures, the POP statement may be replicated such that the statement is present in both loop structures in the appropriate location.

Turning next to FIG. 4, a flowchart of the process for optimizing code using artificial statements is depicted in accordance with a preferred embodiment of the present invention. The process illustrated in FIG. 4 may be implemented in a compiler, such as compiler 300 in FIG. 3.

The process begins by receiving a source code (step 400). Thereafter, an intermediate representation of the source code is generated (step 402). This intermediate representation of the source code is then optimized using artificial statements (step 404). This step may include inserting artificial statements, such as POP statements to cause the compiler to take selected actions depending on the particular statement encountered by the compiler. Thereafter, machine code is generated (step 406) with the process terminating thereafter.

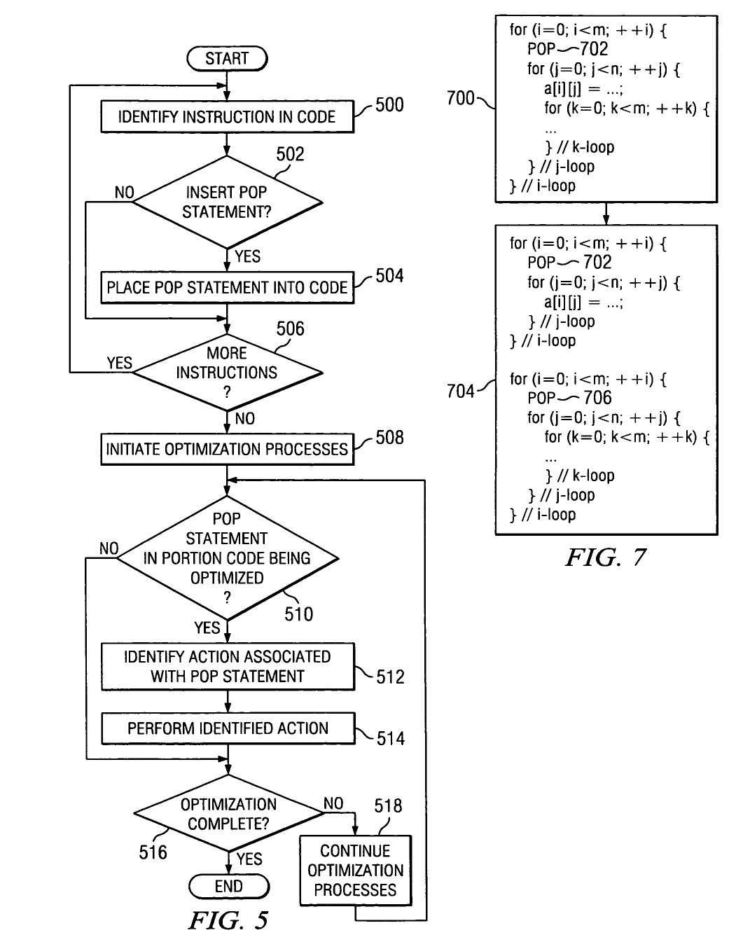

Turning now to FIG. 5, a flowchart of a process for optimizing code using POP statements is depicted in accordance with a preferred embodiment of the present invention. The process illustrated in FIG. 5 may be implemented using a compiler, such as compiler 300 in FIG. 3. In particular, the process illustrated in FIG. 5 is a more detailed description of step 404 in FIG. 4.

The process begins by identifying an instruction in the code (step 500). Thereafter, a determination is made as to whether a POP statement should be inserted into the code with respect to the identified instruction (step 502). This insertion may take different forms depending on the particular implementation. For example, in some cases, the POP statement may be merely inserted into the code in association with the instruction. In another example, the POP statement may actually replace the identified instruction. In these examples, a replacement of the instruction occurs with respect to a store instruction. If the POP statement is to be inserted, the POP statement is placed into the code (step 504). Next, a determination is made as to whether additional instructions are present for processing (step 506). If additional instructions are present, the process returns to (step 500) to identify another instruction for processing.

Otherwise, an optimization process is initiated (step 508). Next, a determination is made as to whether a POP statement is present in the portion of the code being optimized (step 510). If that POP statement is present in the portion of the code being optimized, an action associated with the POP statement is identified (step 512).

The action taken may vary depending on the particular implantation or purpose of the POP statement. For example, the POP statement may merely serve as a reference to keep track of where the original statement was located. For example, a POP statement may replace a store statement such that when an optimization such as dead store elimination is performed, the POP statement remains in place. In contrast, if the original store statement was in place, that statement would be removed depending on the particular location of the statement. Alternatively, the POP statement may result in no operation being performed.

After the action is identified, the identified action is performed (step 514). Thereafter, a determination is made as to whether the optimization has completed (step 516). If the optimization has completed, the process terminates. Otherwise, the optimization process continues (step 518) with the process then returning to step 510. In continuing the optimization process, a different optimization process may be performed or the same optimization process may be performed on a different portion of the code. With reference again to step 510, if the POP statement is not in the portion of the code being optimized, the process proceeds to step 516.

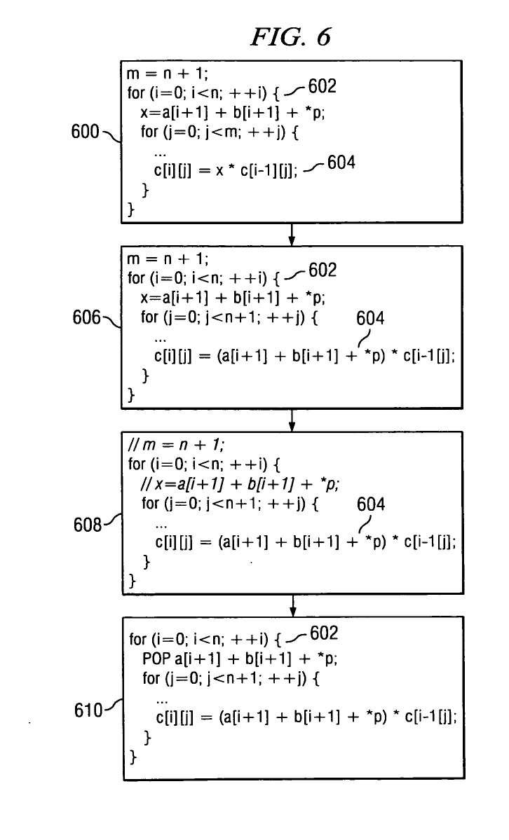

Turning now to FIG. 6, a diagram illustrating optimization of code is depicted in accordance with a preferred embodiment of the present invention. In code 600, the statements illustrated are in an intermediate form for processing by compiler, such as compiler 300 in FIG. 3. The variable p in line 602 is a pointer.

Next, code 604 is generated through aggressive copy propagation. This copy propagation is intended to simplify loop structures and expose additional information for a later analysis and optimization. As can be seen, the variable x in line 604 of code 600 is replaced with the expression for x found in line 602. This replacement is shown in line 604 of code 606 in these examples.

Next, dead store elimination is performed to generate code 608. This type of optimization removes the store into x. As a result, line 602 is no longer present in the code. As a result, the pointer p in line 604 might not be safely moved out of the j-loop although it is loop invariant unless another reference to p is present outside of the j-loop. In contrast, the mechanism of the present invention generates code 610 in which the store into x is replaced with a POP statement in line 602. As a result, the statement in line 602 is not removed when dead store elimination is performed. After loop optimization is performed, the variable p may be moved out of the inner loop by commoning or invariant code motion. Commoning and invariant code motion deal with the elimination of redundant computations. Commoning finds computations that are always performed at least twice on a given execution path and eliminates the second and later occurrences of the computations. Invariant code motion finds computations that produce the same result every time a loop is iterated and moves these computations out of the loop. Dead store elimination eliminates a store into a variable when the variable is not used on any path from where it is defined to the exit point. For example, if two stores to the same location have no intervening load, the first store is unnecessary and removed from this type of process.

As can be seen with line 602 in code 610, all of the information needed for optimization processes, such as commoning and code motion are associated with the POP statement. The POP statements feed into various optimization transforms as normal statements. The mechanism of the present invention treats these types of statements specially in optimizing the code. At the final stage of code generation, the POP statement may be simply ignored.

Turning now to FIG. 7, a diagram illustrating the use of the POP statement and modifying loop structures is depicted in accordance with the preferred embodiment of present invention. In this example, code 700 contains a POP statement in line 702. Code 700 includes three nested loops, a k-loop, a j-loop, and an i-loop. In this example, the j-loop may be split to generate two perfect nests as illustrated in code 704. The POP statement in line 702 is replicated and inserted into the second loop nest in line 706. The POP statements are treated differently than other statements.

Many other uses are present for artificial statements, such as POP statements. Another example is using a POP statement or other artificial statement in pointer alignment analysis. For array references of which the base address is a pointer, the alignment of a base pointer on entry to a loop is computed. This alignment may be used by auto-simdization to generate more efficient code. Internally, artificial uses of base pointers of interest are created via POP statements. Additionally, these POP statements are removed after the analysis completes.

Thus, the present invention provides an improved method, apparatus, and computer instructions for optimizing code through use of artificial statements. The mechanism of the present invention inserts artificial statements into current code or replaces statements in current code with artificial statements to provide for special processing of the code. The artificial statements result in the compiler taking some action when these statements are identified and encountered during processing of the code.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for facilitating optimization of code, the method comprising:
placing an artificial statement into the code, wherein the artificial statement encodes information; and
optimizing the code with a compiler, wherein the compiler performs an action based on the artificial statement in the code.

2. The method of claim 1, wherein the code is an intermediate representation of the source code.

3. The method of claim 2 further comprising:
generating machine code from the code, wherein the artificial statement is treated as a no operation statement.

4. The method of claim 1, wherein the artificial statement replaces a store statement and wherein the optimizing step includes:
performing a dead code elimination operation on the code, wherein the artificial statement is not removed by the dead store operation.

5. The method of claim 1, wherein the artificial statement is located within a loop structure and wherein the optimizing step includes:
splitting a loop structure in the code into a set of loop nests; and
placing copies of the artificial statement into each loop nest in the set of loop nests.

6. The method of claim 1, wherein the artificial statement is marker for expressions being copied to locations in the code.

7. The method of claim 1, wherein the action is at least one of leaving the artificial statement in the code, copying the artificial statement when a loop structure changes.

8. The method of claim 1, wherein the artificial statement is a POP statement.

9. A data processing system in a data processing system for facilitating optimization of code, the data processing system comprising:
placing means for placing an artificial statement into the code, wherein the artificial statement encodes information; and
optimizing means for optimizing the code with a compiler, wherein the compiler performs an action based on the artificial statement in the code.

10. The data processing system of claim 9, wherein the code is an intermediate representation of the source code.

11. The data processing system of claim 10 further comprising:
generating means for generating machine code from the code, wherein the artificial statement is treated as a no operation statement.

12. The data processing system of claim 9, wherein the artificial statement replaces a store statement and wherein the optimizing means includes:
performing means for performing a dead code elimination operation on the code, wherein the artificial statement is not removed by the dead store operation.

13. The data processing system of claim 9, wherein the artificial statement is located within a loop structure and wherein the optimizing means includes:
splitting means for splitting a loop structure in the code into a set of loop nests; and
placing means for placing copies of the artificial statement into each loop nest in the set of loop nests.

14. The data processing system of claim 9, wherein the artificial statement is marker for expressions being copied to locations in the code.

15. The data processing system of claim 9, wherein the action is at least one of leaving the artificial statement in the code, copying the artificial statement when a loop structure changes.

16. The data processing system of claim 9, wherein the artificial statement is a POP statement.

17. A computer program product in a computer readable medium for facilitating optimization of code, the computer program product comprising:
first instructions for placing an artificial statement into the code, wherein the artificial statement encodes information; and
second instructions for optimizing the code with a compiler, wherein the compiler performs an action based on the artificial statement in the code.

18. The computer program product of claim 17, wherein the code is an intermediate representation of the source code.

19. The computer program product of claim 18 further comprising:
third instructions for generating machine code from the code, wherein the artificial statement is treated as a no operation statement.

20. The computer program product of claim 17, wherein the artificial statement replaces a store statement and wherein the second instructions includes:
sub-instructions for performing a dead code elimination operation on the code, wherein the artificial statement is not removed by the dead store operation.

21. The computer program product of claim 17, wherein the artificial statement is located within a loop structure and wherein the second instructions includes:
first sub-instructions for splitting a loop structure in the code into a set of loop nests; and
second sub-instructions for placing copies of the artificial statement into each loop nest in the set of loop nests.

22. The computer program product of claim 17, wherein the artificial statement is marker for expressions being copied to locations in the code.

23. The computer program product of claim 17, wherein the action is at least one of leaving the artificial statement in the code, copying the artificial statement when a loop structure changes.

24. The computer program product of claim 17, wherein the artificial statement is a POP statement.

25. A data processing system comprising:
a bus system;
a memory connected to the bus system, wherein the memory includes a set of instructions; and
a processing unit connected to the bus system, wherein the processing unit executes a set of instruction to place an artificial statement into the code and to optimize the code with a compiler, wherein the compiler performs an action based on the artificial statement in the code.
